(19) United States
(12) Patent Application Publication
(10) Pub. No.: US 2016/0061362 A1
(43) Pub. Date: Mar. 3, 2016

(54) DUCTING APPARATUS

(71) Applicant: HS Wroclaw Sp. z o. o., Wroclaw (PL)

(72) Inventor: Slawomir Kret, Malomice (PL)

(21) Appl. No.: 14/825,524

(22) Filed: Aug. 13, 2015

(30) Foreign Application Priority Data
Aug. 28, 2014 (EP) 14461564.8

(51) Int. Cl. F16L 21/00; F16L 9/18; B29C 49/00

(52) U.S. Cl. CPC F16L 21/00; B29C 49/0042; F16L 9/18

(57) ABSTRACT

The present disclosure generally relates to ducting apparatus and methods, and more specifically a ducting apparatus comprising a duct and a reinforcing member located at an end of the duct to oppose compressive forces that are applied to the duct.

The present disclosure generally relates to ducting apparatus and methods, and more specifically a ducting apparatus comprising a duct and a reinforcing member located at an end of the duct to oppose compressive forces that are applied to the duct.

### BACKGROUND

Fluid ducting, for example air ducting, is frequently required to be fluidly connected. A conventional method of connecting two ducts together is known as “channel band coupling”. In a channel band coupling, a seal is compressed against a common connecting portion of two ducts so as to prevent leakage of fluids at the connecting portion. A fastening mechanism, for example a gasket in the form of a circular clamp, may be used to tighten the seal around the connecting portion.

In some situations it is necessary to provide a reinforcing ring within the duct, for example if the duct is made of a relatively weak material. The reinforcing ring opposes the fastening mechanism and ensures that the seal can be adequately compressed as described above.

A conventional method of securing the reinforcing ring to the inside of the duct is shown in FIG. 1. In the conventional method, an adhesive 3 is placed between the duct 1 and the reinforcing ring 2 to secure the two components together. During manufacturing of ducts, for example by suction blow molding processes, the material may shrink back to form an inner cavity 5 around the internal periphery of the duct 1. In the conventional method, the adhesive 3 extends into this inner cavity 5.

It is desired to improve the method of connecting the reinforcing ring to the duct.

### SUMMARY

In accordance with an aspect of the present disclosure, there is provided a ducting apparatus comprising:

a duct comprising an inner cavity, optionally proximate an end thereof; and

a reinforcing member located within the duct or duct end, and comprising one or more protrusions that extend, or are configured to extend, into the inner cavity of the duct so as to restrict relative movement between the duct and the reinforcing ring.

Thus, the connection of the reinforcing ring to the duct is improved by securing the reinforcing ring to the duct using cooperation of an inner cavity in the duct and one or more protrusions on the reinforcing ring. This means that no adhesive is required to hold the reinforcing ring in place, which reduces the internal diameter of the duct end portion. Lack of an adhesive layer (see FIG. 1) allows greater internal diameter of reinforcing ring. It has been found that the end portion of a duct is also improved when using the present connecting method since the internal diameter of the duct end portion is increased. This reduces the pressure drop across the end portion of the duct. Moreover, manufacturing is simplified since it does not require a bonding process.

It will be appreciated that the disclosed apparatus optionally utilises the inner cavity of the duct that may be formed during manufacture thereof, for example by a blow molding technique, in order to secure and position the reinforcing ring.

The ducting apparatus may be an aircraft ducting apparatus, or may be for use in an aircraft or aerospace environment.

The one or more protrusions may comprise a circumferential bead extending around the periphery of the reinforcing member.

The one or more protrusions may extend into the inner cavity of the duct so as to restrict axial movement of the reinforcing ring relative to the duct and/or the ducting assembly.

A press fit may exist between the duct and the reinforcing member.

The protrusion may have the same, comparable or slightly reduced dimensions as the inner cavity of the duct. The protrusion, for example one or more side edges of the protrusion, may abut the walls of the inner cavity.

The duct may comprise a composite and/or plastic material.

The duct and/or the reinforcing member may comprise a cylindrical ring.

An outer diameter of the reinforcing member may be substantially the same as an inner diameter of the duct.

There may be no adhesive present between the duct and the reinforcing ring.

The duct and the reinforcing ring may not be bonded to one another.

The duct may be a first duct and the duct end may be a first duct end, and the ducting apparatus may further comprise a second duct optionally having a second duct end that is fluidly connected to the first duct end.

The reinforcing member may be a first reinforcing member, the second duct may comprise a second inner cavity proximate an end thereof, and the ducting apparatus may further comprise:

a second reinforcing member located within the second duct end, optionally comprising one or more protrusions extending into the second inner cavity of the second duct so as to restrict relative movement between the second duct and the second reinforcing ring.

The first and second reinforcing members may be part of a common reinforcing member that is optionally located within both first and second duct ends.

The ducting apparatus may further comprise a sealing member surrounding at least a portion of each of the first duct end and the second duct end, wherein optionally the sealing member fluidly seals the connection between the first duct end and the second duct end.

According to an aspect of the present disclosure, there is provided a ducting apparatus comprising:

a duct and a reinforcing member located within the duct, wherein a press fit exists between the duct and the reinforcing member to prevent axial movement between the duct and the reinforcing member.

According to an aspect of the present disclosure, there is provided a method of forming any of the ducting apparatus described above, comprising:

pressing the reinforcing member through the inside diameter of the duct. The pressing may be until the one or more protrusions extend into the inner cavity of the duct.

According to an aspect of the present disclosure, there is provided a method of reinforcing an end of a duct, comprising:

providing a duct such that an inner cavity is formed proximate an end thereof; and

locating a reinforcing member comprising one or more protrusions within the duct end such that the one or more protrusions extend into the inner cavity of the duct so as to restrict relative movement between the duct and the reinforcing ring.

The method may further comprise forming the duct using a blow molding process, for example a suction blow molding process. The inner cavity may be formed due to shrinking of said duct, duct end, duct material or duct end material. The inner cavity may be formed during or after said blow molding process.

According to an aspect of the present disclosure, there is provided a method of manufacturing a reinforced duct, comprising:

forming a duct such that an inner cavity is formed proximate an end thereof; and

locating a reinforcing member comprising one or more protrusions within the duct end such that the one or more protrusions extend into the inner cavity of the duct so as to restrict relative movement between the duct and the reinforcing ring.

The method may further comprise manufacturing the duct using a blow molding process, for example a suction blow molding process. The inner cavity may be formed due to shrinking of said duct, duct end, duct material or duct end material. The inner cavity may be formed during or after said blow molding process.

The reinforcing member according to any of the aspects and embodiments disclosed herein may be a metallic reinforcing member, or comprise metal.

The ducting apparatus according to any of the aspects and embodiments disclosed herein may be referred to as, or be in the form of, a coupling mechanism or a channel band coupling.

### BRIEF DESCRIPTION OF THE DRAWINGS

Various embodiments will now be described, by way of example only, and with reference to the accompanying drawings in which:

FIG. 1 shows a prior art ducting apparatus;

FIG. 2 shows a ducting apparatus according to an embodiment.

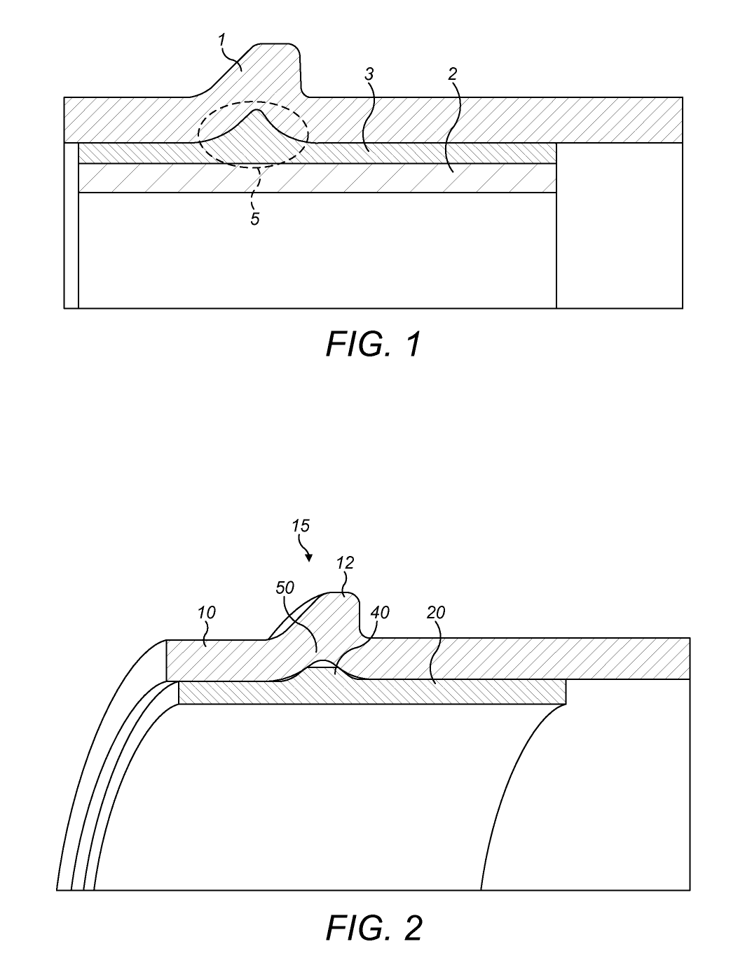

### DETAILED DESCRIPTION

A ducting apparatus in the form of a channel band coupling (not shown) is provided to fluidly connect two ducts. Each duct has a respective duct end and these are situated in close proximity, or connected to one another. A seal is located around and spans across both the duct ends to fluidly seal the connection between the ducts. The seal is compressed against the duct ends using a fastening mechanism, for example a gasket in the form of a circular clamp. The ducts are made from a composite material or plastic and can be liable to collapse if provided without any reinforcement, due to the compression force exerted on the ducts by the fastening mechanism.

Referring now to FIG. 2, in order to oppose this compression force and provide reinforcement a reinforcing ring 20 is provided in each duct 10 proximate the duct end 15. The reinforcing ring 20 is made of a relatively strong material, for example a metallic material, that can adequately oppose the compression force exerted by the fastening mechanism. This prevents the duct end 15 and duct 10 from collapsing when subject to a compressive force.

The reinforcing ring 20 has an outer diameter that is substantially the same as the inner diameter of the duct 10 at duct end 15. Thus, it fits within the duct end 15 in a press fit arrangement between the duct 10 and the reinforcing ring 20.

The duct 10 is manufactured such that the duct end 15 comprises a bead 12, for example using a suction blow molding technique. A side effect of the manufacturing method is that a portion of the internal material of the duct 10 shrinks back to produce an inner cavity 50. The inner cavity 50 is typically in the form of a peripheral cavity, void or notch around the inner circumference of the duct end 15.

The reinforcing ring 20 is provided with a circumferential protrusion or bead 40, that is configured to be located within the inner cavity 50 of the duct 10. The dimensions of the protrusion 40 are comparable to or slightly smaller than the dimensions of the inner cavity 50, such that the protrusion 40 fits within the inner cavity 50 but is restricted from axial movement by abutment of the protrusion 40 with the walls of the inner cavity 50. The restriction of axial movement of the protrusion 40 restricts axial movement of the reinforcing ring 20. This prevents undesired relative movement between the reinforcing ring 20 and the duct 10.

It will be appreciated that the ducting apparatus disclosed herewith does not require the use of an adhesive layer. Instead, the reinforcing ring 20 is held and secured within the duct 10 using a press fit arrangement and/or the engagement of the protrusions 40 with the inner cavity 50. The reinforcing ring 20 may be substantially prevented from axial movement relative to the duct 10 by the one or more protrusions 40, which fit into the inner cavity 50 formed in the interior surface of the duct end 15 during manufacture.

In order to manufacture or assemble the ducting apparatus according to an embodiment, the duct 10 is manufactured with a beaded end using a suction blow molding technique. This forms an inner cavity 50 in the interior surface of the duct end 15. The reinforcing ring 20 is then pressed into the duct end 15 until the protrusion 40 comes into alignment with the inner cavity 50. Once this occurs the protrusion 40 slips into the inner cavity 50. The protrusion 40 abuts the sides of the inner cavity 50 so as to prevent axial movement of the reinforcing ring 20 relative to the duct 10.

This method of manufacture or assembly is advantageous over conventional methods that use adhesive. For example, no bonding process is required and there is also a reduction in materials.

Although the present disclosure has been described with reference to the embodiments described above, it will be understood by those skilled in the art that various changes in form and detail may be made without departing from the scope of the accompanying claims.

1. A ducting apparatus comprising:
a duct comprising an inner cavity proximate an end thereof; and
a reinforcing member located within said duct end comprising one or more protrusions extending into said inner cavity of said duct so as to restrict relative movement between said duct and said reinforcing member.

2. A ducting apparatus as claimed in claim 1, wherein said one or more protrusions comprises a circumferential bead extending around the periphery of said reinforcing member.

3. A ducting apparatus as claimed in claim 1, wherein said one or more protrusions extend into said inner cavity of said duct so as to restrict axial movement of said reinforcing ring relative to said duct.

4. A ducting apparatus as claimed in claim 1, wherein a press fit exists between said duct and said reinforcing member.

5. A ducting apparatus as claimed in claim 1, wherein said duct comprises a composite and/or plastic material.

6. A ducting apparatus as claimed in claim 1, wherein said duct and/or said reinforcing member comprises a cylindrical ring.

7. A ducting apparatus as claimed in claim 1, wherein an outer diameter of said reinforcing member is substantially the same as an inner diameter of said duct.

8. A ducting apparatus as claimed in claim 1, wherein no adhesive is present between said duct and said reinforcing member.

9. A ducting apparatus as claimed in claim 1, wherein said duct and said reinforcing member are not bonded to one another.

10. A ducting apparatus as claimed in claim 1, wherein said duct is a first duct and said duct end is a first duct end, and said ducting apparatus further comprises a second duct having a second duct end that is fluidly connected to said first duct end.

11. A ducting apparatus as claimed in claim 10, wherein said reinforcing member is a first reinforcing member, said second duct comprises a second inner cavity proximate an end thereof, and said ducting apparatus further comprises:
a second reinforcing member located within said second duct end comprising one or more protrusions extending into said second inner cavity of said second duct so as to restrict relative movement between said second duct and said second reinforcing ring.

12. A ducting apparatus as claimed in claim 10, further comprising a sealing member surrounding at least a portion of each of said first duct end and said second duct end, wherein said sealing member fluidly seals said connection between said first duct end and said second duct end.

13. A method of reinforcing an end of a duct, comprising:
forming a duct such that an inner cavity is formed proximate an end thereof; and
locating a reinforcing member comprising one or more protrusions within said duct end such that said one or more protrusions extend into said inner cavity of said duct so as to restrict relative movement between said duct and said reinforcing member.

14. A method as claimed in claim 13, further comprising forming said duct using a blow molding process.

15. A method as claimed in claim 14, wherein said inner cavity is formed due to shrinking of said duct end during or after said blow molding process.
